(19) United States
(12) Patent Application Publication
(10) Pub. No.: US 2024/0033847 A1
(43) Pub. Date: Feb. 1, 2024

(54) METHOD AND CONTROLLER FOR CONTROLLING A LASER PROCESSING PROCESS ON A SURFACE OF A WORKPIECE AND PROCESSING SYSTEM FOR PROCESSING A SURFACE OF A WORKPIECE BY MEANS OF A LASER PROCESSING PROCESS

(71) Applicant: JENOPTIK Automatisierungstechnik GmbH, Jena (DE)

(72) Inventors: Christian DOERING, Jena (DE); Nicolas KROTH, Grossloebichau (DE); Jan LANGENBACH, Gera (DE); André KERN, Jena (DE)

(73) Assignee: JENOPTIK Automatisierungstechnik GmbH, Jena (DE)

(21) Appl. No.: 18/379,488

(22) Filed: Oct. 12, 2023

Related U.S. Application Data
(63) Continuation of application No. PCT/EP2022/059246, filed on Apr. 7, 2022.

(30) Foreign Application Priority Data
Apr. 12, 2021 (DE) 10 2021 109 043.1

(51) Int. Cl. B23K 26/03; B23K 26/0622; B23K 26/082; B23K 26/08

(52) U.S. Cl. CPC B23K 26/032; B23K 26/0622; B23K 26/082; B23K 26/0884

(57) ABSTRACT

A method for controlling a laser processing process on a surface of a workpiece. The method is implementable in conjunction with a processing system. The method includes: bringing about a relative movement between the processing head and the workpiece by the second movement device in order to arrange the processing head in a first processing field of the workpiece; triggering a recording of image data of the processing field by the optical acquisition device; correcting predefined processing coordinates using correction values in order to produce corrected processing coordinates, the correction values being determined in comparison with the predefined processing coordinates using image coordinates; controlling the laser and the first movement device using the corrected processing coordinates in order to process the processing field; and bringing about a further relative movement between the processing head and the workpiece in order to arrange the processing head in a second processing field.

This nonprovisional application is a continuation of International Application No. PCT/EP2022/059246, which was filed on Apr. 7, 2022, and which claims priority to German Patent Application No. DE 10 2021 109 043.1, which was filed in Germany on Apr. 12, 2021, and which are both herein incorporated by reference.

### BACKGROUND OF THE INVENTION

### Field of the Invention

The invention relates to a method for controlling a laser processing process of a surface of a workpiece, to a corresponding controller and to a processing system or processing a surface of a workpiece by means of a laser processing process.

### Description of the Background Art

During the production of components with 3D surfaces in the field of plastics, for example car components, they may for example be injection-molded with the aid of a metal tool. The tool may, in particular, correspond substantially to the CAD or computer-aided design program in which it was developed. The component, on the other hand, may for example be subject to material-specific processes such as shrinkage or distortion, and may deviate after production for example by several millimeters from its injection-molding tool and therefore from the CAD, depending on the circumstances. If such 3D surfaces are intended to be processed, the surface may for example be recorded using a 3D measurement system and the surface thus measured may be made to match optimally with the CAD surface by methods such as, for example, best-fit. Yet since the CAD design and the real component may differ by several millimeters, this alignment may only be carried out with the same accuracy. DE 10 2019 123 654 B3 discloses a method for producing at least one prototype by means of a laser comprising a number of elements.

DE 10 2016 106 648 A1 relates to a calibration method for a sensor deflection system of a laser processing apparatus, wherein a sensor deflection system of a sensor unit, which is optically coupled into a laser deflection system of a processing unit, is calibrated. With a calibrated processing unit, a reference pattern which corresponds to a target pattern stored in a calculation/control unit is created on an object surface, an actual pattern which deviates from the reference pattern because of the uncalibrated sensor deflection system is recorded by means of the sensor unit, and at least one correction value for the sensor deflection system is ascertained by means of an actual/target value comparison.

DE 10 2012 204 715 A1 discloses a painting method for a painted plastic component, wherein paint is removed at least from the inside of the component using a laser unit.

### SUMMARY OF THE INVENTION

It is therefore an object of the present invention to provide an improved method for controlling a laser processing process of a surface of a workpiece, an improved controller for controlling a laser processing process of a surface of a workpiece, and an improved processing system for processing a surface of a workpiece by means of a laser processing process.

A method for processing workpieces, in particular 3D-shaped components or components with 3D surfaces, may be provided, wherein a processing head, which may be equipped with a laser having a beam direction that can be varied, for example by means of a galvanometer scanner, and an optical recording device, for example various cameras or camera systems, may be movable relative to the workpiece. In particular, the optical recording device and a computer for moving the laser beam may be connected to a controller which can carry out evaluation and correction of data. After a corresponding correction, the workpiece may be processed by means of a laser beam, for example with a fixed parameter set of the laser pulses with a pulse energy, a pulse width, a pulse repetition frequency, and a wavelength, and by using the correction data.

In particular, a process stability of the processing process may therefore advantageously be improved. Particularly during processing with a laser, a focal point may be kept within a tolerance so that a stable removal process may be made possible. For example, deviations of the workpiece, for example of an injection-molded component, in respect of its computer-aided design by means of CAD and the real component may be taken into account and minimized in respect of their effects on the processing process. Furthermore, for example, a plurality of processing fields may be joined together without an offset. Precise processing even of large components, which are to be processed with more than one processing field, may therefore be made possible. In addition, measurement of the workpiece by image acquisition may in particular be carried out online, that is to say during the process.

A method for controlling a laser processing process of a surface of a workpiece is proposed, wherein the method can be carried out in conjunction with a processing system which has a processing head having an optical recording device, a laser and a first movement device for moving a laser beam of the laser relative to the workpiece and a second movement device for moving the processing head and the workpiece relative to one another, wherein the method has the following steps: Inducing a relative movement between the processing head and the workpiece by means of the second movement device, in order to arrange the processing head in a region of a first processing field of the workpiece; Initiating acquisition of image data of the processing field by means of the optical recording device; Correcting predefined processing coordinates for the processing of the processing field by using correction values, in order to generate corrected processing coordinates for the processing of the processing field, the correction values being ascertained by using image coordinates determined from the image data of the processing field in comparison with the predefined processing coordinates; Driving the laser and the first movement device by using the corrected processing coordinates, in order to process the processing field; and Inducing a further relative movement between the processing head and the workpiece by means of the second movement device, in order to arrange the processing head in a region of a second processing field of the workpiece, which is different from the first processing field.

The workpiece may be a blank, a semi-finished product, a semi-manufactured product, etc. The surface of the workpiece may be three-dimensionally shaped. The surface may therefore also be referred to as a 3D surface. The processing field may be defined by a maximum movement or deflection of the laser beam, which is limited by the first movement device. The first processing field and the second processing field may be arranged adjacent to one another, spaced apart from one another and additionally or alternatively partially overlapping. The processing fields may be predefined in respect of dimension and location on the workpiece. The first movement device may have a galvanometer scanner, or galvoscanner, a polygon scanner or the like. The second movement device may have a robot, a robot arm, a deformable processing table or the like. When carrying out at least a subset of the steps of the method, at least one control signal for carrying out a respective step may respectively be generated.

After the step of inducing the further relative movement, the initiation step, the correction step, and the driving step may be carried out for the second processing field as a processing field. In other words, the initiation step, the correction step, and the driving step may be carried out for each processing field of the workpiece, it being possible for the step of inducing the further relative movement to be carried out in order to bring the processing head from one processing field to another processing field. Such an example offers the advantage that workpieces having a plurality or multiplicity of processing fields to be processed may be processed precisely, it being possible for a measurement of the processing fields to be carried out during the processing process.

In the step of inducing the relative movement, the relative movement may be induced by using predefined workpiece coordinates and/or by using feature coordinates of the workpiece which have been recorded by means of the optical recording device. Additionally or alternatively, in the step of inducing the further relative movement, the further relative movement may be induced by using predefined workpiece coordinates and/or by using feature coordinates of the workpiece which have been recorded by means of the optical recording device. The feature coordinates may represent at least one impression, indentation, opening, marking, molding, inscription and/or boundary of at least one already processed processing field of the workpiece. Such an example offers the advantage that it is possible to continue seamlessly from a previously processed processing field during the processing of a subsequently processed processing field.

The method may also have a step of initiating a further acquisition of further image data of the processing field in a processed state by means of the optical recording device. In this case, the step of initiating the further acquisition may be carried out after the driving step, in particular directly after the latter. The further image data may be provided for quality control. Such an example offers the advantage that data for quality control may already be collected during the processing process, for example in order to be able to carry out a direct correction of the processing.

Furthermore, in the driving step, a suction device of the processing system may be driven in order to suction process gases and off-gases in the processing field during the processing of the processing field. The processing system may therefore also comprise the suction device. The suction device may be arranged on the processing head. Such an example offers the advantage that the gases may be purposely kept away from a laser beam path and the processing process, the workpiece and a processing cubicle may therefore be protected against contamination.

In addition, in the driving step, the laser may be driven by using a parameter set which is predefined in respect of pulse energy, pulse width, pulse repetition frequency and wavelength of the laser as a function of the workpiece and/or a processing task. Such an example offers the advantage that accurate processing, matched exactly to an actual processing task, may be made possible.

Particularly favorably, variants of this method may for example be implemented in software or hardware or in a hybrid form formed of software and hardware, for example in a controller.

The approach proposed here also provides a controller which is configured to carry out, drive or implement the steps of a variant of a method proposed here in corresponding devices. The object of the invention may also be achieved rapidly and efficiently by this example variant of the invention in the form of a controller.

The approach proposed here also proposes a computer program which can be stored on a machine-readable support or storage medium. The program may be used to carry out and/or drive the steps of the method according to one of the examples described above when the program product or program is executed on a computer, a controller, or an apparatus.

A processing system for processing a surface of a workpiece by means of a laser processing process is also proposed, wherein the processing system has the following features: the controller; and the processing head with the optical recording device, the laser and the first movement device and the second movement device, the controller being connectable or connected to the optical recording device, the laser, the first movement device and the second movement device, in such a way that signals can be transmitted.

In conjunction with the processing system, the controller may advantageously be used or employed to control the laser processing process. In this case, the optical recording device, the laser, and the movement devices may be driven by using control signals generated by means of the controller.

The laser may be configured as a femtosecond laser or a nanosecond laser, in particular as a nanosecond laser with a power of from 50 watts to 500 watts, with a repetition frequency of from 100 kilohertz to 4 megahertz, with a pulse duration of from 30 nanoseconds to 200 nanoseconds and/or with a wavelength of from 1000 nanometers to 1100 nanometers. Such an example offers the advantage that precise processing of the workpiece may be made possible, for example for paint removal from a plastic workpiece.

The optical recording device may also have at least one camera, line scanner, strip scanner or device for laser triangulation. Additionally or alternatively, the optical recording device may be arranged in relation to the first movement device in such a way that a movement of the first movement device for moving the laser beam also induces a movement of a field of view of the optical recording device. In this case, the optical recording device may be directed through a semitransparent mirror into a beam path of the laser beam. Such an example offers the advantage that the optical recording device can always be directed accurately onto the processing field defined by the alignment of the laser beam.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an example of a processing system for processing a surface of a workpiece by means of a laser processing process;

FIG. 2 shows a flowchart of an example of a method for controlling a laser processing process of a surface of a workpiece;

FIG. 3 shows a schematic representation of a workpiece during a laser processing process in conjunction with the method of FIG. 2;

FIG. 4 shows a schematic representation of a workpiece during a laser processing process in conjunction with the method of FIG. 2;

FIG. 5 shows a schematic representation of a workpiece during a laser processing process in conjunction with the method of FIG. 2; and

FIG. 6 shows a schematic representation of a processing field of a workpiece during a laser processing process in conjunction with the method of FIG. 2.

### DETAILED DESCRIPTION

Before examples of the present invention are discussed in more detail below, the backgrounds and fundamentals will first be introduced in brief.

3D components or workpieces with three-dimensionally shaped surfaces may be in sizes of from a few centimeters to a few meters. The first approach for the examples relates in particular to large components or workpieces. Here, the case may arise that a required processing zone cannot be processed by a fixed tool, for example a laser. In this case, the tool should be displaced and optionally applied to the previous processing face. In many applications, it is necessary for this joining of the processing to be carried out in such a way that it is not visible. A challenge in this case is that the CAD data cannot be used as a target specification for the placement. Under certain circumstances, they differ from the real component to such an extent that the junction would be visible. According to the examples, this may advantageously be prevented. If the processing takes place without displacement of the tool, challenges may nevertheless occur. The second approach for the examples relates to several small features in the working region or processing field of the tool, which need to be found with pinpoint accuracy. Here, a deviation between the CAD component, or design, and the real component represents a challenge. Small features have a different distance from one another on the real component than is specified in the CAD component. If processing were in this case to be started according to the CAD target contour, only some features might possibly be processed according to the CAD. Other features sometimes deviate significantly from one another, would not be found with pinpoint accuracy, and would lead to an unusable product. This may also advantageously be prevented according to some examples.

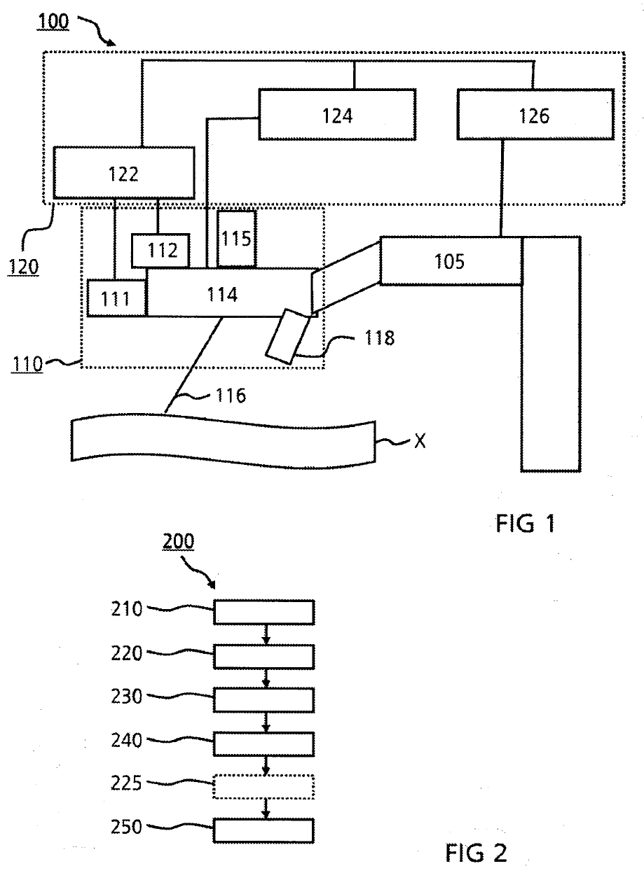

FIG. 1 shows a schematic representation of an example of a processing system 100 for processing a surface of a workpiece X by means of a laser processing process. The processing system 100 comprises a processing head 110 having an optical recording device 111, 112, a laser 115, and a first movement device 114 for moving a laser beam 116 of the laser 115 relative to the workpiece X, and a second movement device 105 for moving the processing head and the workpiece relative to one another. The processing system 101 furthermore comprises a controller 120 for controlling the laser processing process of the surface of the workpiece X. The controller 120 is in this case connected to the optical recording device 111, 112, the first movement device 114, the second movement device 105, and the laser 115 in such a way that signals can be transmitted.

The controller 120 can comprise an image processing device 122, a first control device 124 for the first movement device 114, and a second control device 126 for the second movement device 105. In this case, the second control device 126 is configured to induce a relative movement between the processing head 110 and the workpiece X by means of the second movement device 105, in order to arrange the processing head 110 in a region of a first processing field of the workpiece X. The image processing device 122 is furthermore configured to initiate acquisition of image data of the processing field by means of the optical recording device 111, 112. The image processing device 122, or another device of the controller 120, is also configured to correct predefined processing coordinates for the processing of the processing field by using correction values, in order to generate corrected processing coordinates for the processing of the processing field. In this case, the image processing device 122, or another device of the controller 120, is configured to ascertain the correction values by using image coordinates determined from the image data of the processing field in comparison with the predefined processing coordinates. The first control device 124 is configured to drive the first movement device 114 and the laser 115, by using the corrected processing coordinates in order to process the processing field. The second control device 126 is also configured to induce a further relative movement between the processing head 110 and the workpiece X by means of the second movement device 105 in order to arrange the processing head 110 in a region of a second processing field of the workpiece X, which is different from the first processing field. The controller 120 is configured to then continue the processing on the second processing field as a processing field, at least some of the aforementioned procedures being repeated by means of the image processing device 122 and the first control device 124.

The first control device 124 may be configured to induce the relative movement by using predefined workpiece coordinates and/or by using feature coordinates of the workpiece X which are recorded by means of the optical recording device 111, 112. Additionally or alternatively, the second control device 126 is configured to induce the further relative movement by using predefined workpiece coordinates and/or by using feature coordinates of the workpiece X which are recorded by means of the optical recording device 111, 112. The feature coordinates represent at least one impression, indentation, opening, marking, molding, inscription and/or boundary of at least one already processed processing field of the workpiece X. The feature coordinates represent in particular coordinates of features on the real workpiece X, which may be used for positioning the first and second movement device 114 and 105 (xmn, ymn, zmn). The workpiece X has an extent in three dimensions and is for example in the form of a plastic component in the car industry, for example a bumper, a radiator, etc., and is defined by CAD coordinates (xwn, ywn, zwn), or workpiece coordinates. Positions on the workpiece X, which are intended to be processed by means of the laser beam 116, for example partial removal of layers, are referred to as patterns and are defined by CAD coordinates (xwn, ywn, zwn), or workpiece coordinates.

In particular, the image processing device 122 is connected to at least one camera or optical recording device 111, 112, which is arranged on the processing head 110 or scan head and is moved jointly with the latter. The image processing device 122 is connected to a plurality of cameras 111 and 112 as an optical recording device, which are arranged fixed on the processing head 110 and are moved with the latter. All relevant boundaries of the example represented in FIG. 1, the optical recording device comprises two cameras 111 and 112, although these are indicated merely by way of example and there may be many further variants of their number and positions. The optical recording device 111, 112 is configured to record image coordinates of the workpiece X. The optical recording device 111, 112 comprises at least one camera or line scanner, strip scanner or device for laser triangulation. The optical recording device 111, 112 and the first movement device 114 are connected firmly to one another and can be moved together by means of the second movement device 105. The image processing device 122 is configured to ascertain the correction values between the CAD coordinates and the image coordinates of the workpiece X. The image processing device 122 has an interface to the first control device 124.

The first movement device 114 is configured to move the laser beam 116 relative to the workpiece X in the x, y, and z directions. The processing field, or scan field, is given by the maximum possible deflection of the laser beam 116 in the x, y, and z directions. The first movement device 114 is configured for example as a galvanometer scanner or polygon scanner. The first control device 124 is configured to drive the first movement device 114 in order to move the laser beam 116 relative to the workpiece X. For this purpose, programming of the movement profile of the laser beam 116 according to CAD coordinates of defined patterns on the workpiece X may be used. The first control device 124 has an interface to the image processing device 112. The first control device 124 is configured to carry out a transformation of the processing coordinates according to CAD coordinates into corrected processing coordinates of the real workpiece X by means of correction values of the image processing device 122 and to control the movement of the laser beam 116 relative to the workpiece X according to the corrected processing coordinates after image processing has been carried out.

The second movement device 105 is configured to move the entire processing head 110 relative to the workpiece X. In this case, the second movement device 105 is configured for example as a robot, robot arm, gantry or the like. The further relative movement between the processing head 110 and the workpiece X may be achieved by moving the processing head 110 and/or the workpiece X. The second control device 126 is configured to drive the second movement device 105 in order to induce the relative movement and the further relative movement between the processing head 110 and the workpiece X. The second control device 126 has an interface to the image processing device 122. The second control device 126 is also configured to carry out a transformation of the processing coordinates according to CAD coordinates into corrected processing coordinates of the real workpiece X by means of correction values of the image processing device 122 and to control the movement of the first movement device 114 or of the processing head 110 relative to the workpiece X according to corrected coordinates after image processing has been carried out.

At least one camera or optical recording device 111, 112 can be arranged with respect to the first movement device 114 in such a way that a movement of the first movement device 114 for moving the laser beam 116 also induces a movement of a field of view of the optical recording device 111, 112. In other words, at least one camera or optical recording device 111, 112 is configured so that it looks by means of a semitransparent mirror via the beam path through the scanner or the first movement device 114. A movement of scanner mirrors of the first movement device 114 causes a movement of the field of view of the camera or optical recording device 111, 112, which therefore views in the direction that is dictated by the galvanometer mirror.

The laser 115, or the laser source may be configured as a short-pulse laser such as a femtosecond laser or nanosecond laser. In particular, the laser 115 is configured as a nanosecond laser with a power of from 50 watts to 500 watts, with a repetition frequency of from 100 kilohertz to 4 megahertz, with a pulse duration of from nanoseconds to 200 nanoseconds and/or with a wavelength of from 1000 nanometers to 1100 nanometers. The controller 120, or the first control device 124, may be configured to drive the laser 115 by using a parameter set for the laser 115, or for laser pulses. The parameter set is ascertained in preliminary tests with respective materials of workpieces X and tasks, for example in respect of pulse energy, pulse width, pulse repetition frequency and wavelength of the laser as a function of the workpiece X and/or a processing task. The laser 115 is schematically represented and the laser beam 115 is preferably coupled into the scanner, or the first movement device 114, by means of an optical fiber.

Further, not only is the optical recording device 111, 112 used for adjustment or alignment before the processing of the respective processing field, but further acquisition of further image data of the processing field in a processed state may be initiated by means of the optical recording device 111, 112 and, for example, a camera image is therefore acquired after the processing. This camera image is evaluated separately and optionally compared with a reference image. It is thus used for outcome control or process control of the processing process, for example a removal process.

A suction device 118 can be fitted on the processing head 110, or on the unit formed of the laser 115, first movement device 114 or scanner and optical recording device 111, 112, in such a way that it keeps the process gases and off-gases released during the removal locally and purposely away from the laser beam path and therefore protects the process, the component and the processing cubicle against contamination. The controller 120 is configured to drive the suction device 118 of the processing system 100 in order to suction process gases and off-gases in the processing field during the processing of the processing field.

The first movement device 114, or the scanner, the laser 115 and the optical recording device 111, 112 represent the processing head 110, which is moved as a unit by the second movement device 105. Optionally, the suction device 180 is also jointly mounted on the processing head 110.

FIG. 2 shows a flowchart of an example of a method 200 for controlling a laser processing process of a surface of a workpiece. The control method 200 may in this case be carried out by using the controller of FIG. 1 or a similar controller. The control method 200 may also be carried out in conjunction with the processing system of FIG. 1 or a similar processing system.

The control method 200 may therefore be carried out in conjunction with a processing system which has a processing head having an optical recording device, a laser and a first movement device for moving a laser beam of the laser relative to the workpiece and a second movement device for moving the processing head and the workpiece relative to one another. The control method 200 comprises a step 210 of inducing a relative movement, an initiation step 220, a correction step 230, a driving step 240, and a step 250 of inducing a further relative movement.

In the induction step 210, a relative movement between the processing head and the workpiece is induced by means of the second movement device, in order to arrange the processing head in a region of a first processing field of the workpiece. In the initiation step 220, acquisition of image data of the processing field by means of the optical recording device is then induced. Subsequently in turn, in the correction step 230, predefined processing coordinates for the processing of the processing field are corrected by using correction values in order to generate corrected processing coordinates for the processing of the processing field. The correction values are in this case ascertained by using image coordinates determined from the image data of the processing field in comparison with the predefined processing coordinates. Subsequently, in the driving step 240, the laser and the first movement device are driven by using the corrected processing coordinates in order to process the processing field. In the induction step 250, a further relative movement between the processing head and the workpiece is induced by means of the second movement device in order to arrange the processing head in a region of a second processing field of the workpiece, which is different from the first processing field.

After the step 250 of inducing the further relative movement, the initiation step 220, the correction step 230, and the driving step 240 are carried out for the second processing field as a processing field.

Optionally, the control method 200 additionally comprises a step 225 of initiating a further acquisition of further image data of the processing field in a processed state by means of the optical recording device. The step 224 of initiating the further acquisition is in this case carried out after the driving step 240.

A method is proposed for processing different processing fields on 3D-shaped surfaces by means of a laser, the method having the following steps:

Providing and positioning a 3D-shaped workpiece defined by CAD coordinates (xn, yn, zn),

Providing a laser and a first movement device for carrying out a relative movement between the laser and the workpiece;

Providing a control of the first movement device and programming first processing coordinates (x11n, y11n, z11n) in a first processing field on the basis of the CAD coordinates (xn, yn, zn) of the workpiece;

Providing an image acquisition or optical recording device and positioning relative to the first processing field;

Image acquisition of the first processing field on the workpiece;

Ascertaining correction values between CAD coordinates and image coordinates;

Transmitting the correction values to the first control unit of the first movement unit;

Transforming the first processing coordinates of the first processing field (x11n, y11n, z11n) by means of correction values into second processing coordinates of the first processing field (x12n, y12n, z12n),

Processing the 3D-shaped surface inside the first processing field with the second processing coordinates (x12n, y12n, z12n) and a previously established parameter set of the laser pulses;

Providing a second movement device for a relative movement between the first movement device and the workpiece;

Relative movement of the second movement device to a second processing field;

Image acquisition of the second processing field;

Determining feature coordinates (xm1n, ym1n, zm1n),

Aligning the first movement direction with the feature coordinates (xm1n, ym1n, zm1n),

Repeating steps e. to i. with each subsequent processing field; and

Repeating steps k. to n. with each subsequent processing field.

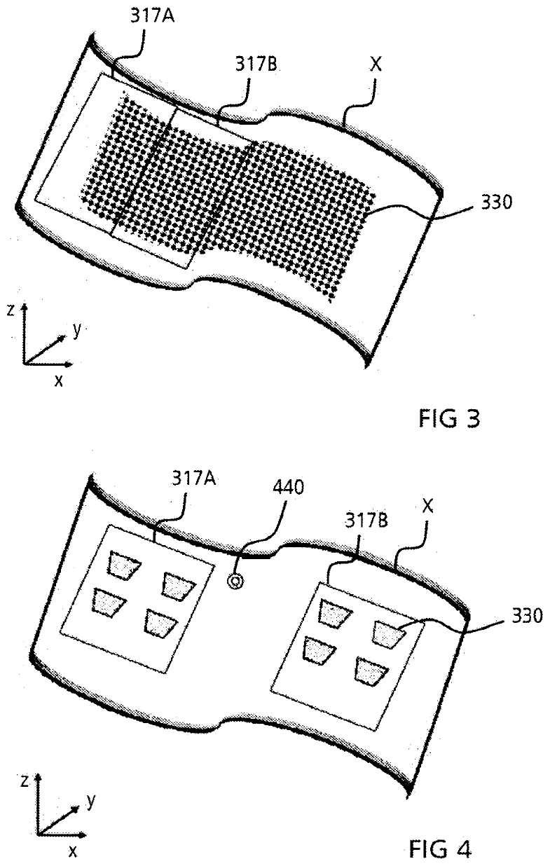

FIG. 3 shows a schematic representation of a workpiece X during a laser processing process in conjunction with the method of FIG. 2. Of the three-dimensional workpiece X, a plurality of regular patterns 330 due to paint removal by means of a laser and two processing fields 317A and 317B are shown in this case by way of example. The patterns 330 in this case extend continuously over an uninterrupted subsection of a surface of the workpiece X. The processing fields 317A and 317B comprise only subregions of the patterns 330. The processing fields 317A and 317B correspond or are similar in this case to the first processing field and the second processing field from one of the figures described above. Each of the processing fields 317A and 317B corresponds to the scan field of a galvanometer scanner as the first movement device of the processing system. FIG. 3 illustrates in particular a seamless concatenation of processing fields 317A, 317B.

FIG. 4 shows a schematic representation of a workpiece X during a laser processing process in conjunction with the method of FIG. 2. The representation in FIG. 4 in this case corresponds to the representation of FIG. 3 with the difference that the patterns 330 are arranged only inside the processing fields 317A and 317B, individual patterns 330 are treated through paint removal by means of a laser and an indentation is additionally indicated by way of example as feature 440 of the workpiece X. FIG. 4 illustrates in particular positioning of individual patterns 330.

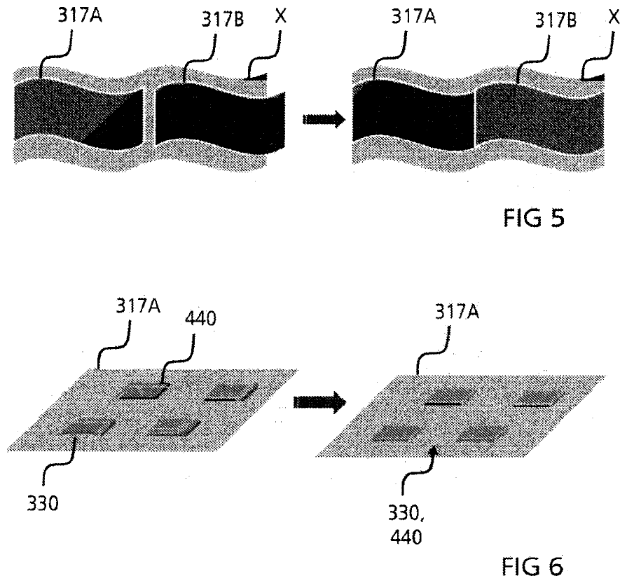

FIG. 5 shows a schematic representation of a workpiece X during a laser processing process in conjunction with the method of FIG. 2. Of the three-dimensional workpiece X, two processing fields 317A and 317B are shown in this case by way of example. The processing fields 317A and 317B correspond or are similar in this case to the first processing field and the second processing field from one of the figures described above. In a partial representation shown on the left in FIG. 5, boundaries of the processing fields 317A and 317B are spaced apart from one another, while the processing fields 317A and 317B are directly adjacent to one another in a partial representation shown on the right. This may be achieved by carrying out the method of FIG. 2 or a similar method.

In other words, FIG. 5 illustrates seamless joining of scan fields, or the processing fields 317A and 317B. The optical recording device of the processing system is placed in such a way that edges of a processing field 317A, 317B respectively to be processed are recorded by the optical recording device. First, the first processing field 317A is processed. The second movement device of the processing system then moves either the workpiece X or the processing head, the scanner being for example mounted on a robot and thereby being displaced. Subsequently, the edges of the previous processing field 317A, 317B are recorded by the optical recording device. A correction is calculated from the information of the camera image. This correction is put, or transformed, onto the target figure of the processing system. This procedure may be repeated for n scan fields. After the alignment, the laser beam processes on the basis of the corrected data.

FIG. 6 shows a schematic representation of a processing field 317A of a workpiece during a laser processing process in conjunction with the method of FIG. 2. Of the workpiece, only the first processing field 317A of the processing fields from one of the figures described above, a plurality of patterns 330 in the processing field 317A and a plurality of real patterns 440 of the workpiece are represented in this case merely by way of example. In a partial representation shown on the left in FIG. 6, the patterns 330 and the features 440 are at least partially offset from one another, while in a partial representation shown on the right the patterns 330 and the features 440 are brought to cover one another. This may be achieved by carrying out the method of FIG. 2 or a similar method.

In other words, FIG. 6 illustrates pinpoint-accuracy processing of individual features, or patterns 330. The optical recording device of the processing system is placed in such a way that the processing field 317A, for example a scan field of a galvanometer scanner, is recorded. Before the processing, an image of the processing surface with the real features 440 present there is acquired. This is followed by alignment of the processing data, for example a scanner file, with the aid of the camera recordings. The alignment may be aligned either per individual feature or (for reasons of operating speed) with a plurality of features combined in a group. After the alignment, the laser beam processes on the basis of the corrected data.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to control a laser processing process of a surface of a workpiece, the method being adapted to be carried out in conjunction with a processing system that comprises a processing head having an optical recording device, a laser, and a first movement device for moving a laser beam of the laser relative to the workpiece and a second movement device for moving the processing head and the workpiece relative to one another, the method comprising:
inducing a relative movement between the processing head and the workpiece via the second movement device in order to arrange the processing head in a region of a first processing field of the workpiece;
initiating acquisition of image data of the processing field via the optical recording device;
correcting processing coordinates predefined on the basis of predefined workpiece coordinates for the processing of the processing field by using correction values in order to generate corrected processing coordinates of the real workpiece for the processing of the processing field, the correction values being ascertained by using image coordinates determined from the image data of the processing field in comparison with the predefined workpiece coordinates;
driving the laser and the first movement device by using the corrected processing coordinates in order to process the processing field; and
inducing a further relative movement between the processing head and the workpiece via the second movement device in order to arrange the processing head in a region of a second processing field of the workpiece, which is different from the first processing field.

2. The method according to claim 1, wherein the initiation step, the correction step, and the driving step are carried out for the second processing field as a processing field after the step of inducing the further relative movement.

3. The method according to claim 1, wherein, in the step of inducing the relative movement, the relative movement is induced by using the predefined workpiece coordinates and/or by using feature coordinates of the workpiece that have been recorded via the optical recording device, and/or wherein, in the step of inducing the further relative movement, the further relative movement is induced by using the predefined workpiece coordinates and/or by using feature coordinates of the workpiece that have been recorded via the optical recording device, the feature coordinates representing at least one impression, indentation, opening, marking, molding, inscription and/or boundary of at least one already processed processing field of the workpiece.

4. The method according to claim 1, further comprising: initiating a further acquisition of further image data of the processing field in a processed state via the optical recording device, the step of initiating the further acquisition being carried out after the driving step.

5. The method according to claim 1, wherein, in the driving step, a suction device of the processing system is driven in order to suction process gases and off-gases in the processing field during the processing of the processing field.

6. The method according to claim 1, wherein, in the driving step, the laser is driven by using a parameter set which is predefined in respect of pulse energy, pulse width, pulse repetition frequency and wavelength of the laser as a function of the workpiece and/or a processing task.

7. A controller comprising:
an image processing device;
a first control device; and
a second control device, the controller being configured to carry out, drive or implement the method according to claim 1.

8. A processing system for processing a surface of a workpiece via a laser processing process, the processing system comprising:
the controller according to claim 7; and
a processing head comprising the optical recording device, the laser and the first movement device and the second movement device,
wherein the controller is connectable or connected to the optical recording device, the laser, the first movement device and the second movement device such that signals are adapted to be transmitted.

9. The processing system according to claim 8, wherein the laser is configured as a femtosecond laser or a nanosecond laser, or as a nanosecond laser with a power of from 50 watts to 500 watts, with a repetition frequency of from 100 kilohertz to 4 megahertz, with a pulse duration of from 30 nanoseconds to 200 nanoseconds and/or with a wavelength of from 1000 nanometers to 1100 nanometers.

10. The processing system according to claim 8, wherein the optical recording device has at least one camera, line scanner, strip scanner or device for laser triangulation, and/or wherein the optical recording device is arranged in relation to the first movement device such that a movement of the first movement device for moving the laser beam also induces a movement of a field of view of the optical recording device.
